(19) United States
(12) Patent Application Publication
(10) Pub. No.: US 2014/0020770 A1
(43) Pub. Date: Jan. 23, 2014

(54) VALVE TYPE DRAIN PLUG FOR VEHICLE TRUNK

(71) Applicant: HYUNDAI MOTOR COMPANY, Seoul (KR)

(72) Inventors: Byeonglag Son, Ulsan (KR); Yeonsu Jung, Ulsan (KR); Yoonhwa Park, Daegu (KR)

(73) Assignee: Hyundai Motor Company, Seoul (KR)

(21) Appl. No.: 13/672,447

(22) Filed: Nov. 8, 2012

(30) Foreign Application Priority Data
Jul. 20, 2012 (KR) 10-2012-0079262

(51) Int. Cl. B62D 25/00

(52) U.S. Cl. CPC B62D 25/00
USPC 137/354

(57) ABSTRACT

A valve type drain plug for a vehicle trunk drains water outward from a trunk room of a vehicle via a drain hole formed in the trunk room and prevents external air from flowing in the trunk room via the drain hole. The valve type drain plug includes a valve and a grommet which are engaged with each other by a slide portion. As the valve is moved, the water flows along the slide portion and is then discharged outward from the trunk.

### CROSS-REFERENCE(S) TO RELATED APPLICATIONS

The present application claims priority of Korean Patent Application Number 10-2012-0079262 filed Jul. 20, 2012, the entire contents of which application is incorporated herein for all purposes by this reference.

### BACKGROUND OF INVENTION

1. Field of Invention

The present invention relates to a valve type drain plug for a vehicle trunk; and, particularly, to a valve type drain plug for a vehicle trunk which drains water outward from a trunk room of a vehicle via a drain hole formed in the trunk room and prevents external air from entering the trunk room via the drain hole.

2. Description of Related Art

FIG. 1A is a plan view schematically illustrating the configuration of a vehicle body of a passenger car, in which the vehicle body is provided with a trunk room at a rear side thereof. The trunk room of the passenger car is closed by trunk lid, but if the vehicle is parked at an outside or traveled in case of heavy rain, water or moisture can enter the trunk room through a gap formed between the trunk lid and the trunk room.

In preparations for the inflow of the water or moisture into the trunk room, a lower panel 2 of the trunk room is provided with drain holes at some positions in order to discharge the water or moisture to the outside of the trunk room. The drain holes are constantly closed by a plug 3, as illustrated in FIG. 1B, but a driver detaches the plug 3 from the lower panel.

The trunk of the vehicle is generally closed, and the vehicle may carry cargo or the like with the trunk room in accordance with a traveling purpose of the vehicle. In this instance, the trunk is opened.

In addition, the trunk includes a locking device for preventing the others from opening the trunk lid by use of several tools.

The trunk includes an outer board, an inner board, and a reinforcing member attached to various mounting parts to increase its strength. That is, a constant space may be formed between the outer board and the inner board of the trunk, and a condensation liquid is generated in the space due to a difference between an interior and exterior of the vehicle.

Also, the drain hole easily discharges an electro-deposition solution from the trunk room for better painting and electro-deposition.

The drain hole should have a function of discharging the water outward and blocking inflow of the external air. Herein, the term “external air” contains exhaust gas of the vehicle itself and polluted air around the vehicle.

When the exhaust gas of the vehicle itself enters a cabin through the trunk room, concentration of carbon monoxide in the vehicle is increased, which may have an effect on a health of a driver and passengers.

In general, only train hole is provided, or as illustrated in FIG. 2, a drain plug 200 is mounted into the drain hole.

In this instance, there is a problem in that the drain plug has a function of reducing a size of the drain hole or discharging the water outward (see Korean Unexamined Patent Publication Nos. 10-2009-0062294, 10-2003-0015006, and 10-2006-0003265).

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for a valve type drain plug for a vehicle trunk which drains water outward from a trunk room of a vehicle via a drain hole formed in the trunk room and prevents external air from flowing in the trunk room via the drain hole.

Various aspects of the present invention provide for a valve type drain plug for a vehicle trunk, including a grommet including a clip portion which is inserted and fixed to an inner panel of the vehicle trunk, a valve insertion hole formed in a center thereof, and a hollow portion which is formed in parallel with the valve insertion hole to discharge a liquid from a vehicle; and a valve which is inserted into the valve insertion hole and is moved upward and downward, the valve having an arrowhead upper end.

The valve may be moved upward to seal the hollow portion when external air enters the vehicle.

The clip portion may have four cross-shaped grooves.

The four cross-shaped grooves may communicate with the hollow portion to discharge the liquid.

With the above configuration of the present invention, the valve type drain plug includes a valve and a grommet which are engaged with each other by a slide portion. As the valve is moved, the water flows along the slide portion and is then discharged outward from the trunk.

Also, when the vehicle travels, indoor air gets out from the vehicle via windows and/or other parts of the vehicle due to the decreased pressure difference between interior and exterior space of the vehicle, and thus the indoor atmospheric pressure is lowered. In this instance, the valve is moved upward, thereby blocking the external air.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1A is a plan view schematically illustrating the configuration of a vehicle body of the related art.

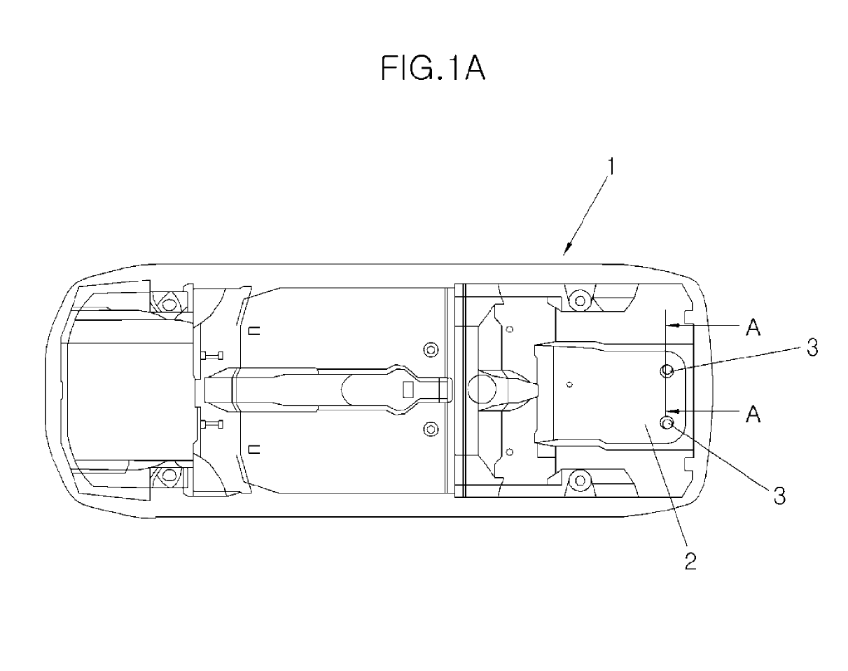

FIG. 1B is a cross-sectional view along the line A-A in FIG. 1A.

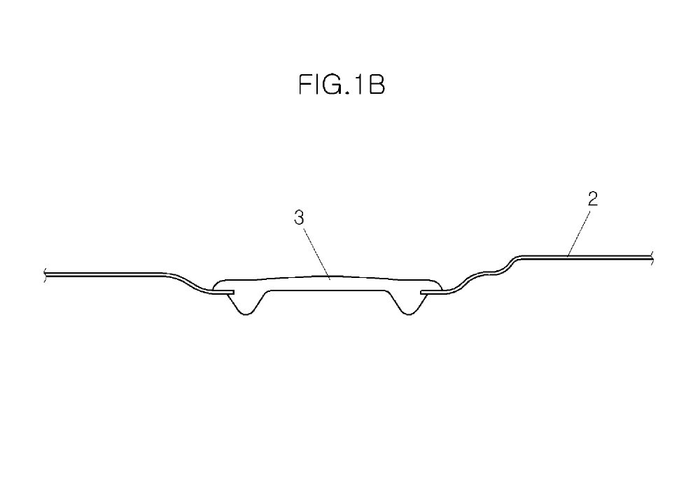

FIG. 2 is a perspective view illustrating a drain plug according to one example of the related art.

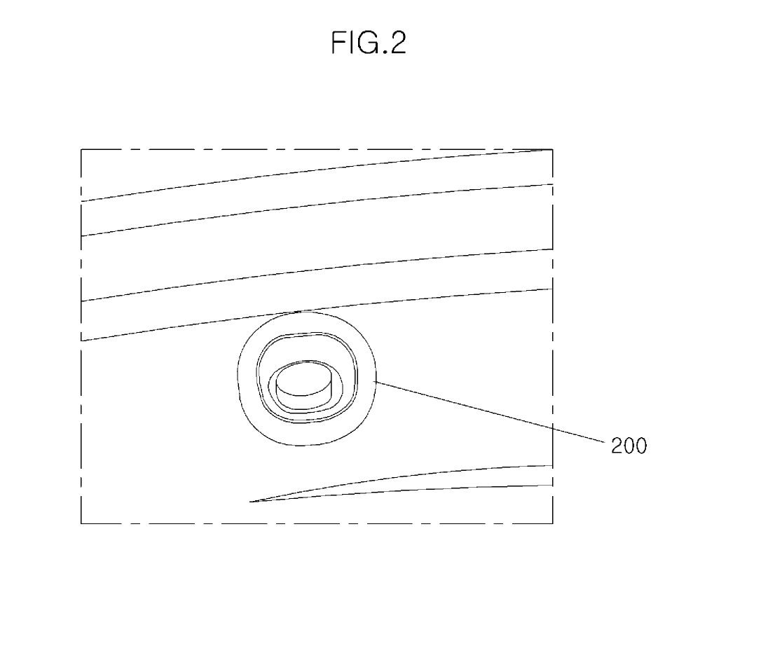

FIG. 3 is a perspective view illustrating an exemplary valve type drain plug according the present invention when seen from a rear side thereof.

FIG. 4 is a perspective view illustrating an assembled state of the drain plug in FIG. 3.

FIG. 5 is a cross-sectional view of the drain plug taken along the line B-B′ in FIG. 3.

FIG. 6 is a perspective view of an exemplary drain plug according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Throughout the disclosure, like reference numerals refer to like parts throughout the various figures and embodiments of the present invention.

It is to be understood that terms, such as first or second, are used to describe various constitutional elements, but the constitutional elements are not limited thereto. These terms are used to distinguish one constitutional element from other constitutional element.

For example, the first constitutional element can be referred to as the second constitutional element, and vice versa. The term “and/or” means a combination of a plurality of elements or any one of the plurality of elements.

Also, it is to be understood that the phraseology and terminology used herein are for the purpose of description, and should not be regarded as limiting. The use of ‘including,’ comprising,' or ‘having’ and variations thereof herein means to encompass the items listed thereafter and equivalents thereof as well as additional items.

Now, a valve type drain plug for a vehicle trunk according to various embodiments of the present invention will now be described with reference to the accompanying drawings.

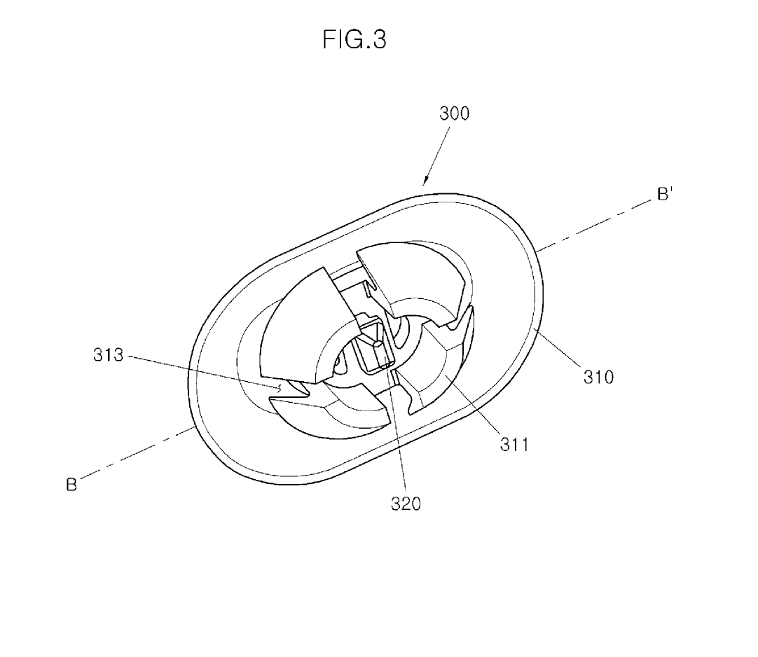

FIG. 3 is a perspective view illustrating a valve type drain plug 300 according to various embodiments of the present invention when seen from a rear side thereof. The valve type drain plug 300 for the vehicle trunk discharges a liquid, such as water, from a trunk room as usual, and is sealed to block inflow of polluted air when external air flows in the vehicle.

Referring to FIG. 3, the valve type drain plug 300 for the vehicle trunk includes a grommet 310 functioning as a cover and provided therein with a clip portion 311 which is inserted into an inner panel of the vehicle trunk, and a valve 320 coupled to the grommet 310 to open or close the grommet 310.

When the vehicle travels, indoor air gets out from the vehicle via windows and/or other parts of the vehicle due to the decreased pressure difference between interior and exterior space of the vehicle, and thus the indoor atmospheric pressure is lowered. In this instance, the valve 320 mounted on the vehicle trunk is moved upward, thereby blocking the external air.

The clip portion 311 is formed in the shape of a four-way clip which forms four cross-shaped grooves 313. When the clip portion 311 is mounted into the drain hole formed in a lower portion of the vehicle trunk, the clip portion can be easily assembled, and be prevented from being released from the drain hole, because of the clip shape.

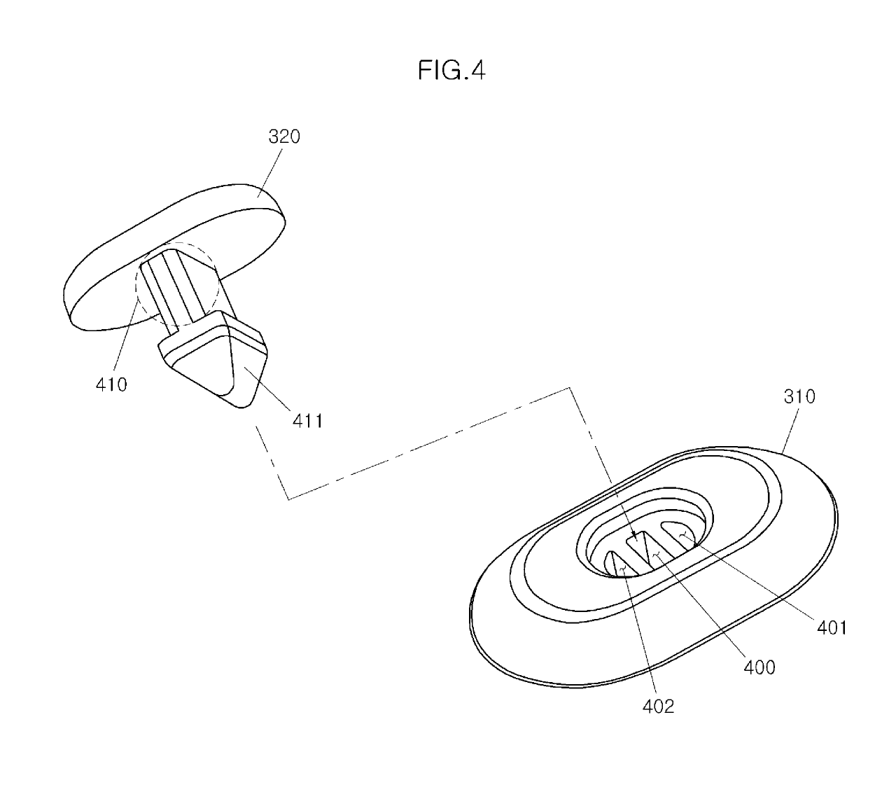

FIG. 4 is a perspective view illustrating an assembled state of the drain plug 300 in FIG. 3. Referring to FIG. 4, the grommet 310 is provided at a center thereof with a rectangular valve insertion hole 400 into which the valve 320 is inserted and assembled. Also, the grommet 310 is provided with hollow portions 401 and 402 formed in parallel with the valve insertion hole 400 to form a passage for the liquid in the vehicle.

The hollow portions 401 and 402 are configured in such a manner that a first hollow portion 401 and a second hollow portion 402 are arranged at both sides of the valve insertion hole 400. The hollow portions 401 and 402 are formed in the shape of a half moon. When the water flows to the grommet 310 in the trunk, the water moves to the valve via the hole of the hollow portions. As a result, the water is discharged outward.

In addition, the valve 320 is provided with an upper end portion 411 which is fastened to the valve insertion hole 400 and/or the hollow portions 401 and 402.

The upper end portion 411 of the valve is inserted into the valve insertion hole 400, and then is moved upward and downward along an inner slide wall of the valve insertion hole 400. Since the upper end portion 411 has an arrowhead at an upper end, the upper end portion 411 is not released from the valve insertion hole 400 after being inserted into the valve insertion hole.

The valve 320 is provided with a valve slide portion 410.

Also, four cross-shaped grooves 313 of the clip portion 311 (FIG. 3) communicate with the hollow portions 401 and 402 to discharge the liquid.

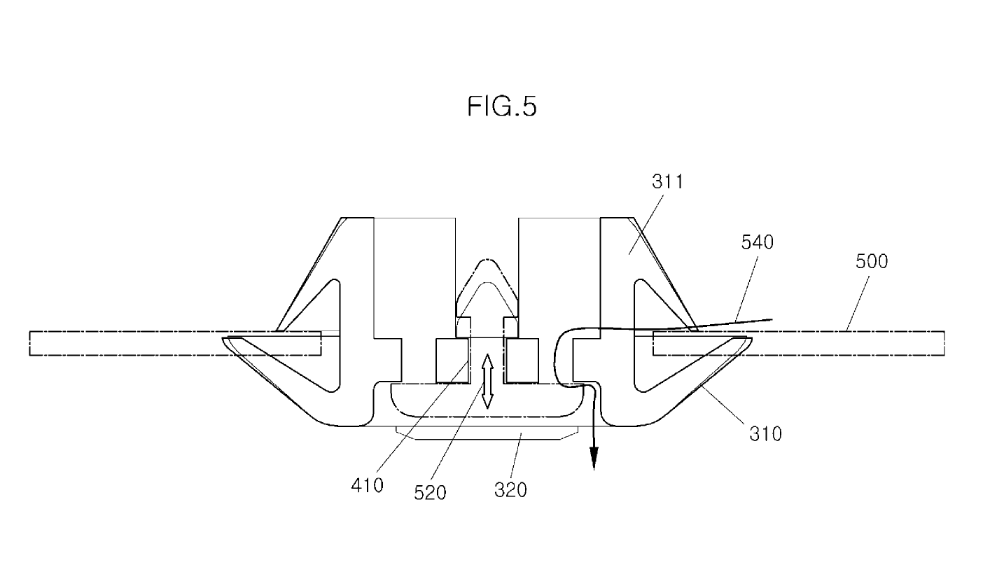

FIG. 5 is a cross-sectional view of the drain plug 300 taken along the line B-B′ in FIG. 3. Referring to FIG. 5, the clip 311 is adapted to be inserted and fixed to the inner panel 500 of the vehicle trunk, and is formed in parallel with the valve insertion hole 400 (FIG. 4) formed at the center of the grommet 310. The hollow portions 401 and 402 are formed in parallel with the valve insertion hole 400 to discharge the liquid from the vehicle. As a result, the clip portions 311 are inserted into the valve insertion hole 400 of the grommet 310, and then are moved upward and downward. The valve 320 having the arrowhead-shaped upper end is inserted, and then is moved in a direction indicated by an arrow 520.

In this instance, the liquid, such as water, collected on the inner panel 500 of the trunk is discharged outward via the valve 320 along a discharge path 540.

In addition, when the grommet 310 is mounted into the drain hall formed in the lower portion of the inner panel 500 of the vehicle trunk, the upper end portion of the grommet is secured to a rip portion of the lower end in a clip shape. This is generally referred to as a grommet fixing method.

According to the structure capable of guiding the water, the clip portions 311 are divided into four directions to form the cross-shaped grooves, and the water flows to the center of the grommet 310 along the cross-shaped grooves 313 (FIG. 3), and is then discharged from the hollow portions 401 and 402 (FIG. 4) which are formed at both sides of the slide.

However, the valve 320 is constantly moved downward by the weight of the valve 320. If the car travels, the internal air is discharged outward from the vehicle due to the difference in atmosphere pressure. At that time, the exterior air is about to enter the trunk, and the valve 320 is moved upward to the upper portion of the grommet 310 by the valve slide 410.

In this instance, the hollow portions 401 and 402, through which the liquid flows, are completely sealed, so that external polluted air, such as exhaust gas, is completely blocked.

The valve 320 is press-fitted into the grommet 310 if the grommet is made from an elastic material, such as rubber and/or TPE (Thermoplastic Elastomer).

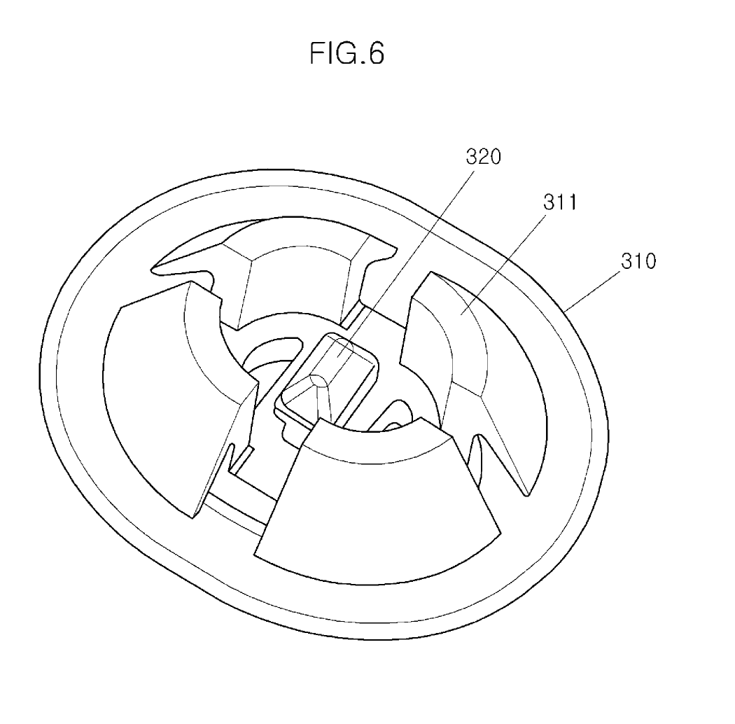

FIG. 6 is a perspective view illustrating a drain plug according to various embodiments of the present invention. Referring to FIG. 6, the grommet 310 is formed in a polygonal shape, and the clip 311 is formed in a polygonal shape around an outer edge thereof.

For convenience in explanation and accurate definition in the appended claims, the terms upper or lower, rear, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A drain plug for a vehicle trunk, comprising:
a grommet including a clip portion inserted and fixed to an inner panel of the vehicle trunk, a valve insertion hole formed in a center thereof, and a hollow portion which is formed parallel with the valve insertion hole to discharge a liquid from the vehicle trunk; and
a valve mounted in the valve insertion hole and is movable upward and downward, the valve having an arrowhead-shaped upper end.

2. The drain plug of claim 1, wherein the valve is moved upward to seal the hollow portion when external air enters the vehicle.

3. The drain plug of claim 1, wherein the clip portion has four cross-shaped grooves.

4. The drain plug of claim 3, wherein the four cross-shaped grooves communicate with the hollow portion to discharge the liquid.
